(19) United States
(12) Patent Application Publication
(10) Pub. No.: US 2013/0136508 A1
(43) Pub. Date: May 30, 2013

(54) DEVELOPING APPARATUS, IMAGE FORMING APPARATUS AND PROCESS CARTRIDGE

(71) Applicant: Shuuichi NAKAGAWA, Osaka (JP)

(72) Inventor: Shuuichi NAKAGAWA, Osaka (JP)

(21) Appl. No.: 13/682,928

(22) Filed: Nov. 21, 2012

(30) Foreign Application Priority Data
Nov. 30, 2011 (JP) 2011-261343

(51) Int. Cl. G03G 15/08

(52) U.S. Cl. CPC G03G 13/08
USPC 399/285

(57) ABSTRACT

To provide a developing apparatus, including: a developer bearing member which carries a one-component developer; a charge imparting member disposed in contact with the developer bearing member and charges the one-component developer on the developer bearing member; and a bias supplying member which supplies a bias voltage to the charge imparting member, wherein the one-component developer has a volume resistivity of 8.0 logΩ·cm to 10.9 logΩ·cm, and the developing apparatus satisfies:

(K−1)^{0.75}/v^{0.25}<0.7×R_{T}−6.6

where:

v [m/sec] is a surface moving speed of a latent image bearing member contacting the developer bearing member at a surface moving in an identical direction as the developer bearing member;

v′ [m/sec] is a surface moving speed of the developer bearing member;

K is a ratio v′/v; and

R_{T} [logΩ·cm] is a volume resistivity of the one-component developer.

### BACKGROUND OF THE INVENTION

1. Field of the Invention

The present invention relates to a developing apparatus which uses a one-component developer to develop a latent image on a latent image bearing member, image forming apparatus equipped therewith such as copier, facsimile and printer, and a process cartridge.

2. Description of the Related Art

Conventionally, development is carried out in this type of image forming apparatus by charging a photoconductor drum to a certain potential followed by forming an electrostatic latent image on a surface of the photoconductor drum by exposure such as laser and LED, further by contacting the photoconductor drum with a developing roller which carries a toner as a one-component developer, and depositing the toner to the electrostatic latent image on the surface of the photoconductor drum.

When a developing apparatus of a one-component developing system is used in the image forming apparatus, the toner on the developing roller is held in a charged and thin-layer state. By a rotation of the developing roller, the toner is conveyed to a developing nip portion where the photoconductor drum and the developing roller are brought into contact. A developing bias voltage is applied to the developing roller, and at the developing nip portion, a developing electric field is formed by a potential difference between the developing roller and the electrostatic latent image on the surface of the photoconductor drum. Development is carried out by a movement of the charged toner in this developing electric field due to an electrostatic force.

In the image forming apparatus which uses the developing apparatus of the one-component developing system, it is necessary that a toner thin layer on the developing roller is sufficiently charged in order to obtain a high-quality image, and various methods for imparting a charge to the toner thin layer have been proposed. For example, an electrostatic image developing apparatus is proposed, in which a thin-layer forming blade made of an elastic material such as rubber and metal is brought into contact with a developing roller, and a toner is regulated by passing through a gap thereof and is frictionally charged at a portion contacting the thin-layer forming blade (see Japanese Patent Application Laid-Open (JP-A) No. 54-43038).

Also, an electrophotographic lithographic printing plate material for which a toner is designed to have a relatively high electrical resistance for maintaining frictional charge and adjusting appropriate charged amount is proposed (see JP-A No. 04-240659).

However, it is difficult to charge frictionally the whole toner in a uniform manner since a toner thin layer is usually in a state of two or more overlapping layers of the toner and there is a distribution on the particle size of the toner. In particular, after the toner is adhered to the photoconductor drum in development, another toner is newly supplied on the developing roller, and the newly supplied toner is mainly not charged. Thus, a sufficient amount of charge cannot be achieved only with the frictional charge by contacting the thin-layer forming blade. This toner with an insufficient amount of charge tends to cause image noise such as ghost image that the insufficient charged amount appears as a difference in the developing concentration when it is next sent to a portion facing the photoconductor drum, and fogging phenomenon that the toner adheres to a background portion.

Further, a one-component developing apparatus which compensates insufficient frictional charges by configuring a thin-layer forming blade with an electrically conductive material and applying a bias voltage to this thin-layer forming blade to inject charges to a toner thin layer (see JP-A No. 10-228173).

In the one-component developing apparatus which injects charges to the toner thin layer as disclosed above in JP-A No. 10-228173, it is considered to set an electrical resistivity of the toner slightly lower than usual for efficient charge injection.

However, when the toner having a slightly lower electrical resistivity is used in the one-component developing apparatus, there are problems of degraded image quality caused by unstable image density and adhesion of a large amount of toner to a background portion since a potential of an electrostatic latent image on a surface of a photoconductor drum changes by a contact with a developing roller.

The present inventors conducted extensive studies on the aforementioned problems. As a result, it was found that, by a developing bias applied on a developing roller, a charge flew from the developing roller to a surface of a photoconductor drum via a toner thin layer and that the surface of the photoconductor drum was subject to injection charging. Moreover, it was also found that slower photoconductor drum increased the time for charge injection, which was likely to cause problems of degraded image quality, and that a larger speed ratio between the photoconductor drum and the developing roller promotes charge propagation in the toner thin layer, which is likely to cause problems of degraded image quality.

### SUMMARY OF THE INVENTION

The present invention aims at providing: a developing apparatus which enables to obtain a high-quality image with stable image density and without adhesion of a one-component developer to a background portion even in the case where the one-component developer has a low electric resistance for effective charge injection to a thin layer of the one-component developer formed on a developer bearing member; an image forming apparatus and a process cartridge which are equipped therewith.

Means for solving the above problems are as follows. That is:

A developing apparatus of the present invention includes:

a developer bearing member which carries a one-component developer;

a charge imparting member which is disposed in contact with the developer bearing member and charges the one-component developer on the developer bearing member; and

a bias supplying member which supplies a bias voltage to the charge imparting member,

wherein the one-component developer has a volume resistivity of 8.0 logΩ·cm to 10.9 logΩ·cm, and

wherein the developing apparatus satisfies the following formula:

(K−1)^{0.75}/v^{0.25}<0.7×R_{T}−6.6

where:

v [m/sec] is a surface moving speed of a latent image bearing member contacting the developer bearing member at a surface moving in an identical direction as the developer bearing member;

v′ [m/sec] is a surface moving speed of the developer bearing member;

K is a ratio v′/v of the surface moving speed between the developer bearing member and the latent image bearing member; and

R_{T} [logΩ·cm] is a volume resistivity of the one-component developer.

According to the present invention, by satisfying the predetermined relation, even when a one-component developer with a low electric resistance which is subject to easy charge injection from a charge imparting member, i.e. one-component developer having a volume resistivity of 8.0 logΩ·cm to 10.9 logΩ·cm, is used, an amount of charge injection from the developer bearing member to a surface of the latent image bearing member may be reduced, and variation of an electrostatic latent image potential at a developing nip portion formed between the developer bearing member and the latent image bearing member may be suppressed. Thereby, an image density is stabilized, and a high-quality image with stable image density and without adhesion of a one-component developer to a background portion may be obtained.

### BRIEF DESCRIPTION OF THE DRAWINGS

FIG. 1 is a schematic configuration diagram illustrating an example of an image forming apparatus having a developing apparatus according to an embodiment of the present invention.

FIG. 2 is a schematic configuration diagram illustrating an example of an overall configuration of a developing apparatus.

FIG. 3A is an explanatory diagram for explaining bias application to a layer regulating member, a developing roller and a photoconductor drum.

FIG. 3B is an equivalent circuit of the current path being biased.

FIG. 4 is a plot illustrating a relation between a developing bias and a potential of a photoconductor after passing through a developing nip.

FIG. 5 is a plot illustrating a relation of a surface moving speed difference of a photoconductor drum and a developing roller at a developing nip portion with an electrical resistance of the toner thin layer.

FIG. 6 is a plot illustrating a relation of an inequality of Formula (3).

FIG. 7 is a plot illustrating a relation of a surface moving speed of a photoconductor drum with a surface moving speed ratio K of the photoconductor drum and a developing roller for four types of toners having a volume resistivity different from one another.

FIG. 8 is a diagram illustrating a sheet on which an image that solid patches are disposed is formed.

### DETAILED DESCRIPTION OF THE INVENTION

### (Developing Apparatus)

A developing apparatus of the present invention includes a developer bearing member which carries a one-component developer, a charge imparting member and a bias supplying member, and it further includes other members according to necessity.

### <Developer Bearing Member>

The developer bearing member is a cylindrical member which carries a one-component developer on a surface thereof and conveys the one-component developer on the surface by rotary drive. Examples thereof include a developing roller.

The developing roller is not particularly restricted in terms of its size, shape, structure or materials, and they may be appropriately selected according to purpose. The materials are not particularly restricted as long as they may be used for an ordinary developing apparatus, and they may be appropriately selected according to purpose. Examples thereof include a non-magnetic material such as stainless steel, aluminum and ceramics, and those coated with a resin layer.

The shape and the size of the developing roller is not particularly restricted as well, and they may be appropriately selected according to purpose. The shape and the size commonly used are preferable.

### <Charge Imparting Member>

The charge imparting member is a member which is disposed in contact with the developer bearing member and charges the one-component developer on the developer bearing member. Examples thereof include a layer regulating member.

The layer regulating member is a member whose free end of a metal plate spring material etc. is disposed in contact with a surface of the developing roller at a predetermined pressing force. It has functions of thinning the toner which passes under the pressing force and imparting frictional charges thereto.

### <Bias Supplying Member>

The bias supplying member is a member which supplies a bias voltage to the charge imparting member, and it can supplement the frictional charging ability.

### <Other Members>

Examples of the other members include a developer containing member and a developer supplying member.

### —Developer Containing Member—

The developer containing member is not particularly restricted as long as it can contain a one-component developer, and it may be appropriately selected according to purpose.

### —Developer Supplying Member—

The developer supplying member is not particularly restricted as long as it supplies a one-component developer to the surface of the developer bearing member, and it may be appropriately selected according to purpose. Examples thereof include a supply roller.

### (Process Cartridge)

A process cartridge of the present invention integrally supports: a latent image bearing member; and a developing apparatus which carries a one-component developer to a developing region facing the latent image bearing member and adheres the one-component developer to a latent image on the latent image bearing member for development, and it further includes other units according to necessity.

As the developing apparatus, the developing apparatus of the present invention is used.

Examples of the other units include a charging unit, an exposure unit and a transfer unit.

### <Latent Image Bearing Member>

The latent image bearing member is not particularly restricted in terms of its materials, shape, structure and size, and they may be appropriately selected according to purpose.

Examples of the shape include a drum, a sheet and an endless belt. The structure may be a single-layer structure or a multi-layer structure. The size may be appropriately selected according to a shape or specifications of the image forming apparatus. Examples of the materials include: an inorganic photoconductor such as amorphous silicon, selenium, CdS and ZnO; and an organic photoconductor (OPC) such as polysilane and phthalopolymethine.

### (Image Forming Apparatus)

An image forming apparatus of the present invention includes: a process cartridge which integrally supports a latent image bearing member, and a developing apparatus which carries a one-component developer to a developing region facing the latent image bearing member and adheres the one-component developer to a latent image on the latent image bearing member for development; and a fixing unit which fixes a transfer image transferred on a recording medium, and it further includes other units according to necessity.

The process cartridge is the process cartridge of the present invention.

Examples of the other units include a cleaning unit and a neutralizing unit.

Hereinafter, an embodiment of the present invention is explained with reference to the drawings.

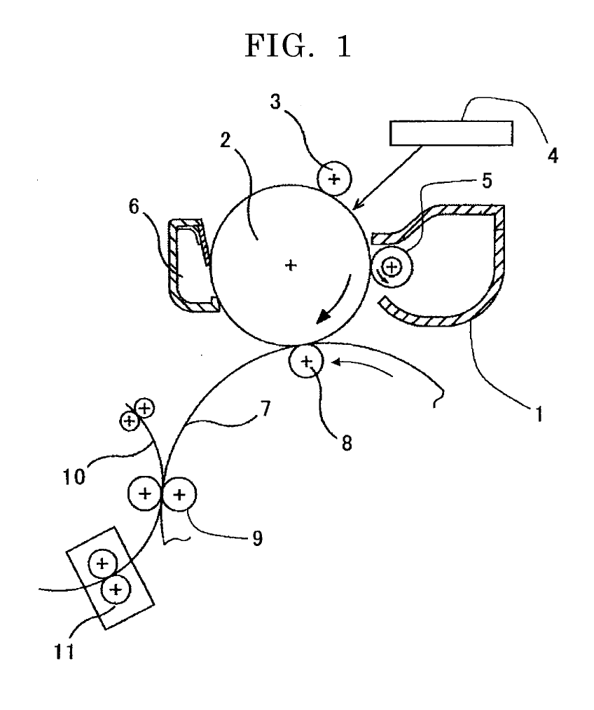

FIG. 1 is a schematic configuration diagram illustrating an example of an image forming apparatus having a developing apparatus according to an embodiment of the present invention.

The image forming apparatus illustrated in FIG. 1 is used for a monochromatic electrophotographic copying machine, a facsimile, a laser printer or a full-color laser printer, for example, and it has a structure including a developing apparatus 1 according to one embodiment of the present invention. This image forming apparatus is mainly configured with: the developing apparatus 1; a photoconductor drum 2 as a latent image bearing member; a charging roller 3 as a charging unit; an exposure unit 4; a photoconductor cleaning unit 6; an intermediate transfer belt 7 as an intermediate transfer member; a primary transfer roller 8 as a primary transfer unit; a secondary transfer roller 9 as a secondary transfer unit; and a fixing apparatus 11 as a fixing unit. Here, a process cartridge which integrally supports at least the developing apparatus 1 and the photoconductor drum 2 among these structural elements and may be detachably mounted to the image forming apparatus may be provided.

The photoconductor drum 2 is disposed in close proximity to the developing apparatus 1, and this photoconductor drum 2 rotates in a direction of an arrow. The charging roller 3 is pressed against a surface of the photoconductor drum 2 and is rotated by the rotation of the photoconductor drum 2. A predetermined bias is applied by a high voltage power source (not shown) to the charging roller 3, and a surface of the photoconductor drum 2 is uniformly charged to a predetermined potential. Thereafter, the photoconductor drum 2 responds to an exposure provided by the exposure unit 4 and forms an electrostatic latent image pattern on the surface thereof.

Also, the developing apparatus 1 is equipped with a developing roller 5 as a developer bearing member which is pressed against the surface of the photoconductor drum 2, and a predetermined developing bias is applied by a high voltage power source (not shown). A toner as a one-component developer supplied on the developing roller 5 is adhered according to an electrostatic latent image pattern on the surface of the photoconductor drum 2 under the potential imparted by the application of the developing bias and forms a toner image.

A primary transfer bias is applied by a high voltage power source (not shown) to the primary transfer roller 8, and the toner image on the surface of the photoconductor drum 2 is transferred to a surface of the intermediate transfer belt 7. The intermediate transfer belt 7 is driven to rotate in a direction of an arrow in the figure by a drive motor (not shown). The toner image formed on the surface of the intermediate transfer belt 7 is transferred onto a sheet 10 as a transfer material by a predetermined secondary transfer bias voltage applied to the secondary transfer roller 9. The sheet 10 on which the toner image has been transferred is output after the toner image is fixed thereon by the fixing apparatus 11. Also, the photoconductor cleaning unit 6 cleans the toner remaining on the surface of the photoconductor drum 2 after transfer.

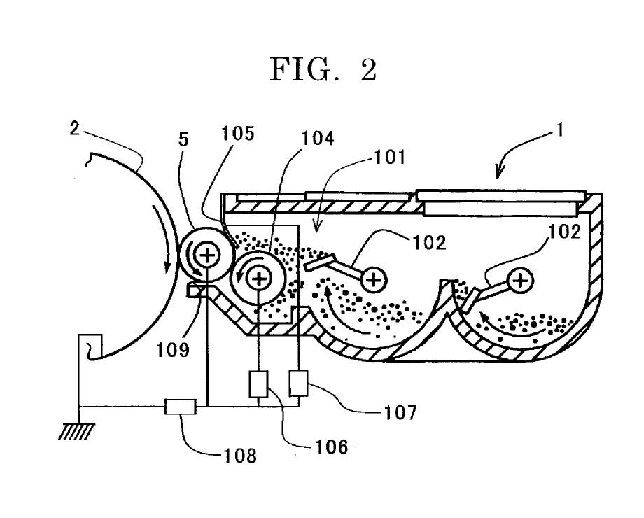

FIG. 2 is a schematic configuration diagram illustrating an example of an overall configuration of the developing apparatus 1.

As shown in FIG. 2, the developing apparatus 1 is provided with, in a toner storage chamber 101 which contains a toner, a plurality of a toner conveying member 102, a developing roller 5, a supply roller 104 as a developer supplying unit disposed in contact with the developing roller 5, and a layer regulating member 105 as a charge imparting member. From a developing bias power source 108 as a developing bias applying unit, a developing bias voltage is applied to the developing roller 5, and a toner image is formed on a surface of a photoconductor drum 2 by moving the toner according to an electric field pattern formed between the developing roller 5 and the surface of the photoconductor drum 2.

The toner conveying members 102 provided in the toner storage chamber 101 rotates in a clockwise direction in FIG. 2 and feeds the toner contained therein to a direction of the supply roller 104. The supply roller 104 has a configuration, for example, that a metal shaft is covered with an electrically conductive foamed rubber layer.

A volume resistivity of the electrically conductive foamed rubber layer is adjusted to about 10⁴Ω·cm by, for example, using a polyurethane rubber foam for the electrically conductive foamed rubber layer and dispersing carbon black as a conductive agent in the foamed rubber. As the electrically conductive foamed rubber layer, epichlorohydrin rubber, silicone rubber and ethylene-propylene-diene rubber (EPDM) may also be used other than polyurethane.

The supply roller 104 rotates in a counterclockwise direction in FIG. 2 and conveys the toner which is adhered and held on a surface thereof to a location facing the developing roller 5. Also, deformation of the foam by the supply roller 104 being pressed against the developing roller 5 sends out the toner held by the supply roller 104 to the surface of the developing roller 5 for coating and supplying. Further, a supply bias is applied to the supply roller 104 from a supply bias power source 106 as a supply bias applying unit, and a supply electric field is formed between the supply roller 104 and the developing roller 5. In this embodiment, application of the supply bias of a DC voltage offset by −100V with respect to the developing roller 5 functions to promote coating and supplying of the toner from the supply roller 104 to the surface of the developing roller 5 by an electrostatic force.

The layer regulating member 105 is a member whose free end of a metal plate spring material of SUS301CSP is disposed in contact with the surface of the developing roller 5 at a predetermined pressing force (e.g. about 20 N/m). It has functions of thinning the toner which passes under the pressing force and imparting frictional charges thereto.

As the metal plate spring material, SUS304CSP or phosphor bronze may also be used, for example, other than SUS301CSP. Also, as the layer regulating member 105, a resin or a rubber material processed into a film or a block, or a roller-shaped member may also be used other than the metal plate spring material as long as it is accompanied by a unit biasing in a direction of the developing roller 5.

It is adequate that the pressing force of the layer regulating member 105 is 10 N/m to 80 N/m. The pressing force of a higher setting increases frictional charging ability but promotes degradation of the toner due to strong damage to the toner. Accordingly, a slightly lower setting is preferable.

The pressing force of the layer regulating member may be calculated by setting a developing roller having pressure sensors attached at three locations in an axis direction of a surface of the developing roller in a developing apparatus and taking an average of measurement values of the three locations when the layer regulating member is contacted to a measurement surface of the pressure sensors. Here, the surface of the developing roller of the locations at which the pressure sensors are attached is processed to have a concave shape so that the measurement surface of the pressure sensors has the same level as the outer periphery of the developing roller.

In the present invention, a layer regulating bias of −100V DC is applied to the layer regulating member 105 from a layer regulating bias power source 107 as a bias power source member for the purpose of supplementing the frictional charging ability. The layer regulating bias functions to homogenize the charging condition of the overall toner layer by increasing the charge of the toner by means of charge injection to the thin-layered toner. A DC voltage offset with respect to the developing roller in the same direction as a charge polarity of the toner is often used for the layer regulating bias, but there are also cases where superimposing an AC voltage is effective. In addition, a plurality of the layer regulating member 105 may be disposed, and at this time, the layer regulating bias may be applied only to at least one of the layer regulating members.

The developing roller 5 rotates in a counterclockwise direction in FIG. 2 and conveys the toner coated and supplied by the supply roller 104, while maintaining it on a surface thereof, to positions facing the layer regulating member 105 and the photoconductor drum 2, respectively. In order to maintain a required amount of the toner on the surface, it is preferable that the developing roller 5 is designed to have a surface roughness Ra of 0.2 μm to 2.0 μm. The developing roller 5 has a configuration that an electrically conductive rubber layer is provided on an outer periphery of a metal shaft.

The surface roughness Ra of the developing roller may be measured using a surface roughness measuring device SV3000, manufactured by Mitutoyo Corporation, under the following conditions. Here, 9 locations in total, 3 locations in an axial direction×3 locations in a peripheral directions, are selected as measurement locations, and an average value thereof is calculated.
measurement distance per one location: 2.5 mm

stylus radius: 2 μm
stylus moving direction: axis direction
stylus moving speed: 10 mm/sec
cut-off: λc (2.5 mm); λs (0.08 mm)

As a material of the electrically conductive rubber layer, a urethane rubber may be used, for example. It is also possible to use an epichlorohydrin rubber, a silicone rubber or an ethylene-propylene-diene rubber (EPDM). Also, in the present embodiment, the electrically conductive rubber layer has a thickness of 3 mm, and the developing roller 5 has a surface elasticity in JIS-A hardness of 45°, but the JIS-A hardness of 50° or less suffices for maintaining a uniform contact state with the photoconductor drum 2. Further, in order to frictionally charge the toner with the layer regulating member 105, a material which may be easily charged to a polarity opposite to the toner is selected for the electrically conductive rubber layer on the surface of the developing roller 5.

The photoconductor drum 2 rotates in a clockwise direction in FIG. 2, and the surface of the developing roller 5 moves in the same direction as the travelling direction of the photoconductor drum 2 at the location facing the photoconductor drum 2. The developing bias is applied on the developing roller 5 from the developing bias power source 108, and a developing electric field is formed between the developing roller 5 and an electrostatic latent image pattern on the photoconductor drum 2. The charged toner is navigated to the surface of the photoconductor drum 2 in accordance with the developing electric field and is developed. In order for this developing bias to function, the developing roller 5 is required to have a semiconductive electrical resistance including the elastic rubber layer and the surface layer of 10³Ω to 10⁷Ω, and in the present embodiment, the volume resistivity is adjusted to about 10⁵Ω·cm by dispersing carbon black as an electrically conductive agent in the rubber.

At a portion where the toner which has not been developed on the photoconductor drum 2 and remains on the developing roller 5 returns to the toner containing chamber 101, an inlet seal 109 is provided in contact with the developing roller 5, and the toner is sealed so as not to leak out to an outside of the developing apparatus.

In order to obtain an effect of an auxiliary charge by the charge injection from the layer regulating member 105, the toner is preferably designed to have a formulation for a volume resistivity of 10.9 logΩ·cm or less. However, when the volume resistivity is too low, a charge retention ability of the toner is reduced, causing problems such as difficulty in overlaying the toner of plural colors in a transfer step during a color image formation. Thus, the volume resistivity is preferably 8.0 logΩ·cm or greater.

The volume resistivity of the toner may be adjusted by varying a number of parts and dispersion condition of carbon black included in the toner

In the present embodiment, the volume resistivity of the toner is measured in accordance with the following procedure.

(1) A disk-shaped pellet having a thickness of about 3 mm is prepared by applying a load of 6 ton/cm² for 1 minute to 3 g of toner particles in a cylindrical shape having a diameter of 4 cm using an electric pressing machine manufactured by Maekawa Testing Co., Ltd.

(2) Next, this pellet is set in a dielectric loss measuring instrument TR-10C (manufactured by Ando Electric Co., Ltd.), and its volume resistivity is measured. As measurement conditions, the frequency is 1 kHz, and RATIO is 1×10⁻⁹. Then, a logarithmic value of the measured value is taken, and the volume resistivity in [logΩ·cm] is obtained.

Next, a result of an experiment on a relation among a surface moving speed of the photoconductor drum 2, a surface moving speed of the developing roller 5 and the volume resistivity of the toner is explained.

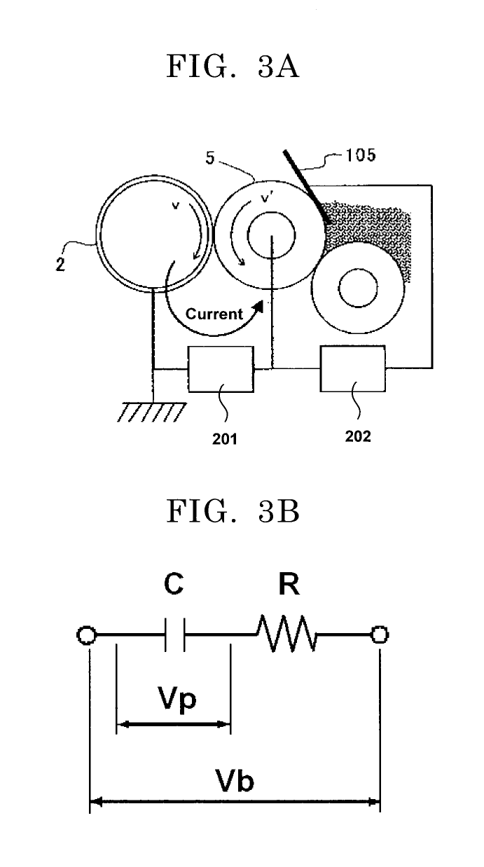

FIG. 3A is an explanatory diagram for explaining bias application to a layer regulating member 105, a developing roller 5 and a photoconductor drum 2, and FIG. 3B is an equivalent circuit of the current path being biased. In FIG. 3A, 202 denotes a layer regulating bias.

In FIG. 3A, at a developing nip portion of the developing apparatus 1 using a one-component developing method, charge flows to a surface of the photoconductor drum 2 from the developing roller 5 via a toner thin layer due to the developing bias 201 applied to the developing roller 5, and by the charge injected to the surface of the photoconductor drum 2, a potential of a latent image on the surface of the photoconductor drum 2 changes. Regarding a current path in this case, as shown in FIG. 3B, an equivalent circuit may be expressed as a series circuit of R and C, where R is an electrical resistance of the toner thin layer at a contact surface in the developing nip portion, and C is a photoconductor capacitance at the contact surface in the developing nip portion.

With Vb as the developing bias and Vp as the voltage applied on a dielectric layer on the surface of the photoconductor drum 2, Vp is characterized to approach Vb over time and is represented by Formula (1) below.

Vp=Vb(1−e^{t/RC}) (1)

In Formula (1), Vp represents a surface potential of the photoconductor drum 2, and time t represents a time required for the photoconductor drum 2 to pass through the developing nip portion. Also, e is a base of natural logarithms. Thus, it is understood from Formula (1) that a slower speed of the photoconductor drum 2 increases the time t and accordingly that the electrostatic latent image potential of the photoconductor drum 2 approaches more closely to the value of the developing bias.

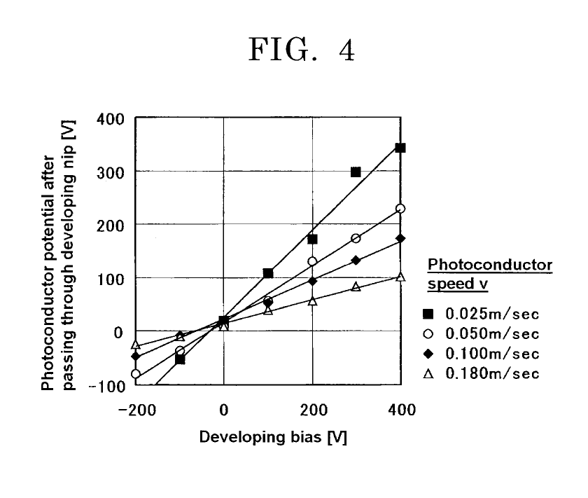

FIG. 4 is a plot illustrating a relation between a developing bias and a potential of a photoconductor after passing through a developing nip, and it is an experimental data at different conditions in which the speed of the photoconductor drum 2 is varied. It shows a relation between the developing bias and the surface potential of the photoconductor drum 2 which is initially zero and changes as passing through the developing nip portion. It is understood from this plot that the electrostatic latent image potential of the photoconductor drum 2 approaches more to the value of the developing bias as the speed of the photoconductor drum 2 decreases.

For the value of the photoconductor capacitance C in Formula (1), it is possible to manipulate it by a thickness of a photoconductive layer as a dielectric layer of the photoconductor drum 2. The value of the photoconductor capacitance increases as the thickness of the photoconductive layer decreases, and thus it becomes easier to suppress a change in the electrostatic latent image potential of the photoconductor drum 2.

Also, for the value of the resistivity R in Formula (1), it is possible to manipulate it by a difference in speed between the photoconductor drum 2 and the developing roller 5, or the volume resistivity of the toner.

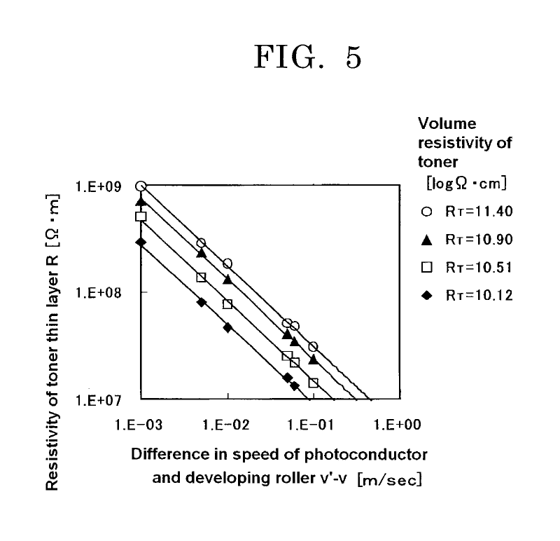

FIG. 5 is a plot illustrating a relation of a surface moving speed difference between a photoconductor drum 2 and a developing roller 5 at a developing nip portion with an electrical resistance of the toner thin layer. As shown in FIG. 5, in an experiment where the surface moving speed difference between the photoconductor drum 2 and the developing roller 5 was varied, there was no change observed at all in the electrostatic latent image potential of the photoconductor drum 2 in the case where they had an equal surface moving speed. However, when the surface moving speed difference was increased, the electrical resistance R of the toner thin layer decreased, and a potential change of the electrostatic latent image of the photoconductor drum 2 increased. This is because the surface moving speed difference activated the toner flow in the developing nip and increased the conductive paths. It was also confirmed by the experiment that the toner having a lower volume resistivity resulted in a larger potential difference in the electrostatic latent image.

From the experimental result, when the surface moving speed of the photoconductor drum 2, the surface moving speed of the developing roller 5 and the volume resistivity of the toner are defined as v [m/sec], v′ [m/sec] and R_{T} [logΩ·cm], respectively, they have a relation with the resistance R of the toner thin layer as expressed by Formula (2) below.

R=[(3.3×R_{T}−32.3)×10⁶]/(v′−v)^{0.75} (2)

The surface moving speed of the photoconductor drum as a latent image bearing member v and the surface moving speed of the developing roller as a developer bearing member v′ may be obtained by measuring a rotational speed (rpm) of a rotational axis using a commercially available non-contact tachometer and converting it to a surface speed based on a circumference of the latent image bearing member and the developer bearing member.

From the theoretical equation (1) and the experimental equation (2), a condition for suppressing an amount of change in the potential of the electrostatic latent image of the photoconductor drum 2 to less than 20% of the potential difference between the electrostatic latent image potential and the developing bias is derived, and Formula (3) below is obtained with a surface moving speed ratio of the photoconductor drum 2 and the developing roller v′/v regarded as K.

(K−1)^{0.75}/v^{0.25}<0.7×R_{T}−6.6 (3)

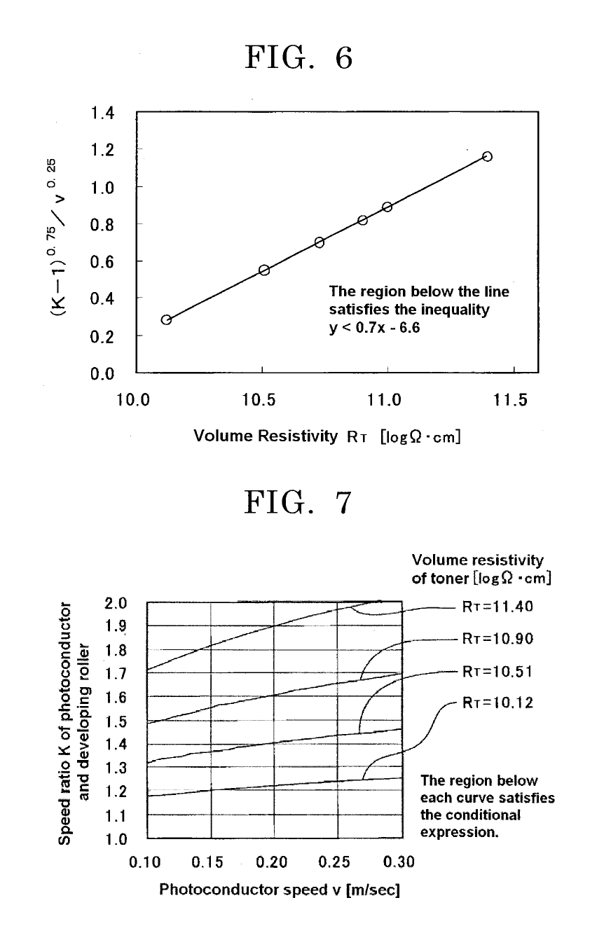

FIG. 6 is a plot illustrating a relation of the inequality of Formula (3). The region below the line in FIG. 6 is a region where the inequality of Formula (3) is satisfied.

FIG. 7 is a plot illustrating a relation between a surface moving speed of a photoconductor drum 2 and a surface moving speed ratio K of the photoconductor drum 2 and a developing roller 5 for four types of toners having a volume resistivity R_{T} different from one another prepared as follows. The region below each curve in FIG. 7 is a region where the inequality of Formula (3) is satisfied.

<Four Types of Toners Having Volume Resistivity R_{T} Different from One Another>
(1) As a toner having a volume resistivity R_{T} of 11.40, IPSIO SP C320 manufactured by Ricoh Company Ltd., was used.
(2) As a toner having a volume resistivity R_{T} of 10.90, a toner of Sample A produced as below was used.
(3) As a toner having a volume resistivity R_{T} of 10.51, a toner of Sample B produced as below was used.
(4) As a toner having a volume resistivity R_{T} of 10.12, MAGICOLOR 5430, manufactured by Konica Minolta was used.

### <<Method for Manufacturing Toner of Sample A>>

### —Synthesis of Polyester 1—

In a reactor equipped with a cooling tube, a stirrer and a nitrogen inlet tube, 235 parts by mass of ethylene oxide 2-mole adduct of bisphenol A, 525 parts by mass of propylene oxide 3-mole adduct of bisphenol A, 205 parts by mass of terephthalic acid, 47 parts by mass of adipic acid, and 2 parts by mass of dibutyltin oxide were placed, which were reacted under a normal pressure, at 230° C. for 8 hours and further reacted at a reduced pressure of 10 mmHg to 15 mmHg for 5 hours. The reactor was charged with 46 parts by mass of trimellitic anhydride, and after reacting under a normal pressure, at 180° C. for 2 hours, [Polyester 1] was obtained. Obtained [Polyester 1] had a number-average molecular weight of 2,600, a weight-average molecular weight of 6,900, Tg of 44° C., and an acid value of 26 mgKOH/g.

### —Synthesis of Prepolymer 1—

In a reactor equipped with a cooling tube, a stirrer, and a nitrogen inlet tube, 682 parts by mass of ethylene oxide 2-mole adduct of bisphenol A, 81 parts by mass of propylene oxide 2-mole adduct of bisphenol A, 283 parts by mass of terephthalic acid, 22 parts by mass of trimellitic anhydride, and 2 parts by mass of dibutyltin oxide were placed, which were reacted under a normal pressure, at 230° C. for 8 hours, and further reacted under a reduced pressure of 10 mmHg to 15 mmHg for 5 hours, and [Intermediate Polyester 1] was obtained.

[Intermediate Polyester 1] had a number-average molecular weight of 2,100, a weight-average molecular weight of 9,500, Tg of 55° C., an acid value of 0.5 mgKOH/g, and a hydroxyl value of 49 mgKOH/g.

Next, in a reactor equipped with a cooling tube, a stirrer, and a nitrogen inlet tube, 411 parts by mass of [Intermediate Polyester 1], 89 parts by mass of isophorone diisocyanate, and 500 parts by mass of ethyl acetate were placed, which was reacted at 100° C. for 5 hours, and [Prepolymer 1] was obtained. Free isocyanate in [Prepolymer 1] in % by mass was 1.53%.

### —Preparation of Masterbatch 1—

First, 30 parts by mass of carbon black (REGAL 400R, manufactured by Cabot), 70 parts by mass of a polyester resin (RS-801, manufactured by Sanyo Chemical Industries, Ltd.; acid value: 10 mgKOH/g; Mw: 20,000; Tg: 64° C.) as a binder resin, and 30 parts by mass of water were mixed in a HENSCHEL mixer, and a mixture that water is soaked in pigment agglomeration was obtained. This was kneaded for 45 minutes with two rolls whose surface temperature was set at 130° C. and pulverized with a pulverizer to a size of 1 mm, and [Masterbatch 1] was obtained.

### —Preparation of Pigment and Wax Dispersion 1 (Oil Phase)—

A container equipped with a stirring rod and a thermometer was charged with 545 parts by mass of [Polyester 1], 181 parts by mass of paraffin wax, and 1,450 parts by mass of ethyl acetate, heated to 80° C. with stirring, maintained at 80° C. for 5 hours, and cooled to 30° C. over 1 hour. Next, the container was charged with 500 parts by mass of [masterbatch 1] and 100 parts by mass of ethyl acetate, which was mixed for 1 hour, and [Raw Material Solution 1] was obtained.

Then, 1,500 parts by mass of [Raw Material Solution 1] was transferred to a container, and using a bead mill (ULTRA VISCO MILL, manufactured by Aimex Co., Ltd.), dispersion of the carbon black and the wax was carried out by running three passes under the following conditions: feed rate of a liquid feed rate was 1 kg/hr; a peripheral speed of a disk was 6 m/s; zirconia beads having a diameter of 0.5 mm were packed by 80% by volume. Next, 655 parts by mass of 66−% by mass ethyl acetate solution of [Polyester 1] above was added, which was ran one pass with the bead mill under the above conditions, and [Pigment and Wax Dispersion 1] was obtained. Ethyl acetate was added so that a solid content concentration of [Pigment and Wax Dispersion 1] (130° C., 30 minutes) was adjusted to 50% by mass.

### —Aqueous Phase Preparation Step—

A milky liquid was obtained by mixing and stirring: 970 parts by mass of ion-exchanged water; 40 parts by mass of 25−% by mass aqueous dispersion of organic resin particles for stable dispersion (a copolymer of styrene—methacrylic acid—butyl acrylate—sodium salt of sulfate ester of methacrylic acid ethylene oxide adduct); 140 parts by mass of 48.5−% by mass aqueous solution of dodecyl diphenyl ether disulfonate (ET EMINOL MON-7, manufactured by Sanyo Chemical Industries, Ltd.); and 90 parts by mass of ethyl acetate. This was defined as [Aqueous Phase 1].

### —Emulsification Step—

First, 975 parts by mass of [Pigment and Wax Dispersion 1] and 2.6 parts by mass of Isophoronediamine as amines were mixed with a TK HOMOMIXER (manufactured by Primix Corporation) at 5,000 rpm for 1 minute. Then, 88 parts by mass of [Prepolymer 1] were added and mixed with the TK HOMOMIXER (manufactured by Primix Corporation) at 5,000 rpm for 1 minute, to which 1,200 parts by mass of [Aqueous Phase 1] was added. This was mixed with the TK HOMOMIXER with a number of rotations adjusted to 8,000 rpm to 13,000 rpm for 20 minutes, and [Emulsified Slurry 1] was obtained.

### —Desolvation Step—

In a container equipped with a stirrer and a thermometer, [Emulsified Slurry 1] was placed, and desolvation was carried out at 30° C. for 8 hours, and, [Dispersion Slurry 1] was obtained.

### —Washing and Drying Step—

After vacuum filtration of 100 parts by mass of obtained [Dispersion Slurry 1], washing and drying was carried out as follows.
(1): 100 parts by mass of ion-exchanged water was added to a filter cake, which was mixed with a TK HOMOMIXER (at 12,000 rpm for 10 minutes) and then filtered. The filtrate was milky white.
(2): To the filter cake of (1), 900 parts by mass of ion-exchanged water was added, which was subjected to ultrasonic vibration, mixed with a TK HOMOMIXER (at 12,000 rpm for 30 minutes), and subjected to vacuum filtration. This operation was repeated so that the reslurried liquid had an electrical conductivity of 10 μC/cm or less.
(3): 10−% by mass hydrochloric acid was added so that the reslurried liquid of (2) had a pH of 4, which was stirred as it was with a three-one motor for 30 minutes, followed by filtration.
(4): 100 parts by mass of ion-exchanged water was added to the filter cake of (3), which was mixed with a TK HOMOMIXER (at 12,000 rpm for 10 minutes), followed by filtration. This operation was repeated so that the reslurried liquid had an electrical conductivity of 10 μC/cm or less, and [Filter Cake 1] was obtained.

[Filter Cake 1] was dried in a wind dryer at 42° C. for 48 hours and then sieved with a mesh having openings of 75 μm, and [Toner Base 101] was obtained. The toner base obtained had an average circularity of 0.974, a volume-average particle diameter (Dv) of 6.3 μm, a number-average particle diameter (Dp) of 5.3 μm, and a particle size distribution of Dv/Dp of 1.19.

Next, to 100 parts by mass of the obtained toner base, 1.8 parts by mass of hydrophobic silica was mixed with a HENSCHEL mixer, and [Toner of Sample A] was obtained.

### <<Method for Producing Toner of Sample B>>

[Toner of Sample B] was obtained in the same manner as the [Method for manufacturing toner of sample A] except that the [preparation of masterbatch 1] was changed to [preparation of masterbatch 2] below.

### —Preparation of Masterbatch 2—

First, 55 parts by mass of carbon black (REGAL 400R, manufactured by Cabot), 45 parts by mass of a polyester resin (RS-801, manufactured by Sanyo Chemical Industries, Ltd.; acid value: 10 mgKOH/g; Mw: 20,000; Tg: 64° C.) as a binder resin, and 30 parts by mass of water were mixed in a HENSCHEL mixer, and a mixture that water is soaked in pigment agglomeration was obtained. This was kneaded for 80 minutes with two rolls whose surface temperature was set at 100° C. and pulverized with a pulverizer to a size of 1 mm, and [Masterbatch 2] was obtained.

### EXAMPLES

The following describes examples with specific numerical values are set for the volume resistivity R_{T} of the toner, the surface moving speed v of the photoconductor drum 2 and the surface moving speed v′ of the developing roller 5.

### Example 1

In the first example (Example 1), a toner storage chamber 101 was filled with a toner having a volume resistance of 10.51 logΩ·cm. As the toner of Example 1, Toner of Sample B above was used. Also, a metal substrate having an outer diameter of 30 mm with a photoconductive layer having a thickness of 27 μm provided on a surface thereof was used as a photoconductor drum 2, and a surface moving speed v of the photoconductor drum 2 was set at 0.15 m/sec. As the photoconductor drum of Example 1, IPSIO SP C320 manufactured by Ricoh Company, Ltd. was used.

A developing roller 5 had a diameter of 12 mm, and a surface moving speed was set at 0.195 m/sec so that the surface moving speed was 1.3 times the speed of the photoconductor drum 2. Potentials of a electrostatic latent image pattern formed on a surface of the photoconductor drum 2 were configured such that the potentials were −70V at an image portion and −500V at a background portion. These setting conditions satisfied the relation of Formula (3) below.

(K−1)^{0.75}/v^{0.25}(≈0.651)<0.7×R_{T}−6.6(=0.757)

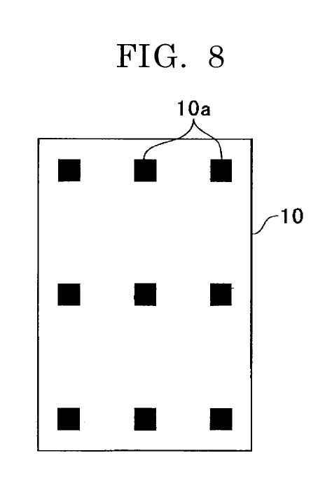

Using an image forming apparatus equipped with a developing apparatus of Example 1, an image that patched images (hereinafter referred to as a “solid patch”) 10a each consisting of a solid image of 2 cm×2 cm were arranged at 9 locations on portrait paper 10 of size A4 as illustrated in FIG. 8 was printed, and the developing bias voltage was set at −250V so that the solid patches 10a had an average reflection density of 1.4. As a result, it was confirmed that a difference between a maximum value and a minimum value of the reflection density of the solid patches 10a at 9 locations was suppressed to 0.05. Reflection density was measured using a transmission and reflection densitometer 310, manufactured by X-Rite.

In addition, the toner was removed from the surface of the photoconductor drum 2 immediately after development of the solid patches, and the surface potential thereof was measured. The potential of −70V before development was changed to −93V, and the amount of change, i.e. the amount of change in the potential of the electrostatic latent image, was only −23V. Surface potential was measured using MODEL 344, manufactured by TREK.

In this way, it is possible to reduce the amount of charge injection from the developing roller 5 to the surface of the photoconductor drum 2 and to suppress the change in the potential of the electrostatic latent image at the developing nip portion formed between the developing roller 5 and the photoconductor drum 2. Accordingly, a high-quality image having a stable image density without toner adhesion to a background region may be obtained.

### Example 2

In the second example (Example 2), a toner storage chamber 101 was filled with a toner having a volume resistance of 10.90 logΩ·cm. As the toner of Example 2, Toner of Sample A above was used. Also, a metal substrate having an outer diameter of 30 mm with a photoconductive layer having a thickness of 22 μm provided on a surface thereof was used as the photoconductor drum 2, and a surface moving speed of the photoconductor drum was set at 0.10 m/sec. As the photoconductor drum of Example 2, IPSIO SP C320, manufactured by Ricoh Company, Ltd., was used.

A developing roller 5 had a diameter of 12 mm, and a surface moving speed v′ was set at 0.145 m/sec so that the surface moving speed was 1.45 times the speed of the photoconductor drum 2. Potentials of an electrostatic latent image pattern formed on the surface of the photoconductor drum 2 were configured such that the potentials were −70V at an image portion and −500V at a background portion. These setting conditions satisfied the relation of Formula (3) below.

(K−1)^{0.75}/v^{0.25}(≠1.977)<0.7×R_{T}−6.6(=1.03)

Using an image forming apparatus equipped with a developing apparatus of Example 2, similarly to Example 1, an image in which solid patches 10a of 2 cm×2 cm were arranged at 9 locations on portrait paper 10 of size A4 as illustrated in FIG. 8 was printed. The developing bias voltage was adjusted so that the solid patches 10a had an average reflection density of 1.4, and it was −200V. As a result, it was confirmed that a difference between a maximum value and a minimum value of the reflection density of the solid patches 10a at 9 locations was suppressed to 0.03. Reflection density was measured in the same manner as Example 1.

In addition, the toner was removed from the surface of the photoconductor drum 2 immediately after development of the solid patches, and the surface potential thereof was measured. The potential, which was −70V before development, was changed to −85V, and the amount of change, i.e. the amount of change in the potential of the electrostatic latent image, was only −15V. Surface potential was measured in the same manner as Example 1. Accordingly, a high-quality image having a stable image density without toner adhesion to a background region may be obtained.

Here, the photoconductive layer having a thickness of 22 μm was provided on the surface of the metal substrate of the photoconductor drum 2 as described above. According to a result of experiments conducted by the present inventors, the thickness of the photoconductive layer is preferably 27 μm or less, and more preferably 25 μm or less. As the thickness of the photoconductive layer is reduced, the capacitance at the developing nip portion increases, and a time constant of charge injection increases. As a result, the amount of charge injection within the time required for the surface of the photoconductor drum 2 to pass through the developing nip is reduced, making it easier to suppress the change in the electrostatic latent image potential.

### Comparative Example 1

Next, a comparative example is explained.

A toner storage chamber 101 was filled with a toner having a volume resistance of 10.51 logΩ·cm. As the toner of Comparative Example 1, Toner of Sample B above was used.

Also, a metal substrate having an outer diameter of 30 mm with a photoconductive layer having a thickness of 27 μm provided on a surface thereof was used as a photoconductor drum 2, and a surface moving speed v of the photoconductor drum was set at 0.15 m/sec. As the photoconductor drum of Comparative Example 1, IPSIO SP C320, manufactured by Ricoh Company, Ltd., was used.

A surface moving speed v′ of a developing roller 5 was set at 0.218 m/sec so that the surface moving speed was 1.45 times the speed of the photoconductor drum 2. These setting conditions did not satisfy the relation of Formula (3) below.

(K−1)^{0.75}/v^{0.25}(≠0.883)>0.7×R_{T}−6.6(=0.757)

Also, similarly to Examples 1 and 2, an image in which solid patches 10a of 2 cm×2 cm were arranged at 9 locations on portrait paper 10 of size A4 as illustrated in FIG. 8 was printed. The developing bias voltage was adjusted so that the solid patches 10a had an average reflection density of 1.4, and it was −290V. As a result, it was confirmed that a difference between a maximum value and a minimum value of the reflection density of the solid patches 10a at 9 locations was 0.11, which was considerably large compared to Examples 1 and 2. Reflection density was measured in the same manner as Example 1.

In addition, the toner was removed from the surface of the photoconductor drum 2 immediately after development of the solid patches, and the surface potential thereof was measured. The potential, which was −70V before development, was changed to −138V, and the amount of change, i.e. the amount of change in the potential of the electrostatic latent image, was −68V. Surface potential was measured in the same manner as Example 1.

In Comparative Example 1, the amount of charge injection from the developing roller 5 to the surface of the photoconductor drum 2 is large, and the change in the potential of the electrostatic latent image at the developing nip formed between the developing roller 5 and the photoconductor drum 2 cannot be suppressed. Thus, there is a possibility that the image density is not stable, resulting in an image with toner adhesion to the background portion.

Those explained above are only examples, and the present invention has an effect specific to each of the following aspects.

### (Aspect A)

It is a developing apparatus including; a developer bearing member such as developing roller 5 which carries a one-component developer such as toner; a charge imparting member such as layer regulating member 105 which is disposed in contact with the developer bearing member and charges the one-component developer on the developer bearing member; and a bias supplying member such as layer regulating bias power source 107 which supplies a bias voltage to the charge imparting member, wherein the one-component developer has a volume resistivity of 8.0 logΩ·cm to 10.9 logΩ·cm, and wherein the developing apparatus satisfies the following formula:

(K−1)^{0.75}/v^{0.25}<0.7×R_{T}−6.6

where:

v [m/sec] is a surface moving speed of a latent image bearing member such as photoconductor drum 2 contacting the developer bearing member at a surface moving in an identical direction as the developer bearing member; v′ [m/sec] is a surface moving speed of the developer bearing member; K is a ratio of the surface moving speeds of the developer bearing member and the latent image bearing member, v′/v; and R_{T} [logΩ·cm] is a volume resistivity of the one-component developer. According to this aspect, as the embodiment is explained above, by satisfying the predetermined relation, even when a one-component developer with a low electric resistance which is subject to easy charge injection from a charge imparting member, i.e. one-component developer having a volume resistivity of 8.0 logΩ·cm to 10.9 logΩ·cm, is used, an amount of charge injection from the developer bearing member to a surface of the latent image bearing member may be reduced, and variation of an electrostatic latent image potential at a developing nip portion formed between the developer bearing member and the latent image bearing member may be suppressed. Thereby, an image density is stabilized, and a high-quality image with stable image density and without adhesion of a one-component developer to a background portion may be obtained.

### (Aspect B)

It is a process cartridge which integrally supports: a latent image bearing member; and a developing apparatus which carries a one-component developer to a developing region facing the latent image bearing member and adheres the one-component developer to a latent image on the latent image bearing member for development, wherein the developing apparatus of Aspect A is used as the developing apparatus, and wherein a dielectric layer such as photoconductive layer on a surface of the latent image bearing member has a thickness measured as follows of 25 μm or less. According to this aspect, as explained in Example 2 of the embodiment, by reducing the thickness of the dielectric layer at the surface of the latent image bearing member to 25 μm or less, a capacitance at the developing nip portion increases, and a time constant of charge injection increases. As a result, the amount of charge injection within the time required for the surface of the photoconductor drum 2 to pass through the developing nip is reduced, making it easier to suppress the change in the electrostatic latent image potential.

### <Method for Measuring Thickness of Dielectric Layer>

A part of a dielectric layer was peeled off with a solvent, and a difference in height between the peeled portion and a non-peeled portion using a surface roughness measuring device SV3000, manufactured by Mitutoyo Corporation. Measurements were taken at 3 locations in an axial direction, and an average value was calculated.

Aspects of the present invention are as follows.

<1> A Developing Apparatus, including:

a developer bearing member which carries a one-component developer;

a charge imparting member which is disposed in contact with the developer bearing member and charges the one-component developer on the developer bearing member; and

a bias supplying member which supplies a bias voltage to the charge imparting member,

wherein the one-component developer has a volume resistivity of 8.0 logΩ·cm to 10.9 logΩ·cm, and

wherein the developing apparatus satisfies the following formula:

(K−1)^{0.75}/v^{0.25}<0.7×R_{T}−6.6

where:

v [m/sec] is a surface moving speed of a latent image bearing member contacting the developer bearing member at a surface moving in an identical direction as the developer bearing member;

v′ [misec] is a surface moving speed of the developer bearing member;

K is a ratio v′/v of the surface moving speed of the developer bearing member and the surface moving speed of the latent image bearing member; and

R_{T} [logΩ·cm] is a volume resistivity of the one-component developer.

<2> The developing apparatus according to <1>, wherein the volume resistivity of the one-component developer is 10.1 logΩ·cm to 10.9 logΩ·cm.
<3> The developing apparatus according to any one of <1> to <2>, wherein the surface moving speed v of the latent image bearing member is 0.1 m/sec to 0.15 m/sec.
<4> The developing apparatus according to any one of <1> to <3>, wherein the developer bearing member has a surface roughness Ra of 0.2 μm to 2.0 μm.
<5> The developing apparatus according to any one of <1> to <4>, wherein the charge imparting member is a layer regulating member, and wherein the layer regulating member includes a metal spring material.
<6> The developing apparatus according to <5>, wherein a free end of the layer regulating member has a pressing force of 10 N/m to 80 N/m.
<7> A process cartridge, including:

a latent image bearing member; and

a developing apparatus which carries a one-component developer to a developing region facing the latent image bearing member and adheres the one-component developer to a latent image on the latent image bearing member for development,

wherein the process cartridge integrally supports the latent image bearing member and the developing apparatus, and

wherein the developing apparatus is the developing apparatus according to any one of <1> to <6>.

<8> The process cartridge according to <7>, wherein the latent image bearing member has a dielectric layer on a surface thereof, and the dielectric layer has a thickness of 25 μm or less.
<9> An image forming apparatus including a process cartridge and a fixing unit,

wherein the process cartridge includes:
a latent image bearing member; and
a developing apparatus which carries a one-component developer to a developing region facing the latent image bearing member and adheres the one-component developer to a latent image on the latent image bearing member for development,

wherein the process cartridge integrally supports the latent image bearing member and the developing apparatus,

wherein the fixing unit fixes a transfer image transferred on a recording medium, and

wherein the process cartridge is the process cartridge according to any one of <7> to <8>.

This application claims priority to Japanese application No. 2011-261343, filed on Nov. 30, 2011 and incorporated herein by reference.

What is claimed is:

1. A developing apparatus, comprising:
a developer bearing member which carries a one-component developer;
a charge imparting member which is disposed in contact with the developer bearing member and charges the one-component developer on the developer bearing member; and
a bias supplying member which supplies a bias voltage to the charge imparting member,
wherein the one-component developer has a volume resistivity of 8.0 logΩ·cm to 10.9 logΩ·cm, and
wherein the developing apparatus satisfies the following formula:
(K−1)^{0.75}/v^{0.25}<0.7×R_{T}−6.6
where:
v [m/sec] is a surface moving speed of a latent image bearing member contacting the developer bearing member at a surface moving in an identical direction as the developer bearing member;
v′ [m/se] is a surface moving speed of the developer bearing member;
K is a ratio v′/v of the surface moving speed of the developer bearing member and the surface moving speed of the latent image bearing member; and
R_{T} [logΩ·cm] is a volume resistivity of the one-component developer.

2. The developing apparatus according to claim 1, wherein the volume resistivity of the one-component developer is 10.1 logΩ·cm to 10.9 logΩ·cm.

3. The developing apparatus according to claim 1, wherein the surface moving speed v of the latent image bearing member is 0.1 m/sec to 0.15 m/sec.

4. The developing apparatus according to claim 1, wherein the developer bearing member has a surface roughness Ra of 0.2 μm to 2.0 μm.

5. The developing apparatus according to claim 1, wherein the charge imparting member is a layer regulating member, and wherein the layer regulating member comprises a metal spring material.

6. The developing apparatus according to claim 5, wherein a free end of the layer regulating member has a pressing force of 10 N/m to 80 N/m.

7. A process cartridge, comprising:
a latent image bearing member; and
a developing apparatus which carries a one-component developer to a developing region facing the latent image bearing member and adheres the one-component developer to a latent image on the latent image bearing member for development,
wherein the process cartridge integrally supports the latent image bearing member and the developing apparatus,
wherein the developing apparatus includes:
a developer bearing member which carries the one-component developer;
a charge imparting member which is disposed in contact with the developer bearing member and charges the one-component developer on the developer bearing member; and
a bias supplying member which supplies a bias voltage to the charge imparting member,
wherein the one-component developer has a volume resistivity of 8.0 logΩ·cm to 10.9 logΩ·cm, and
wherein the developing apparatus satisfies the following formula:
(K−1)^{0.75}/v^{0.25}<0.7×R_{T}−6.6
where:
v [m/sec] is a surface moving speed of the latent image bearing member contacting the developer bearing member at a surface moving in an identical direction as the developer bearing member;
v′ [m/sec] is a surface moving speed of the developer bearing member;
K is a ratio v′/v of the surface moving speed of the developer bearing member and the surface moving speed of the latent image bearing member; and
R_{T} [logΩ·cm] is a volume resistivity of the one-component developer.

8. The process cartridge according to claim 7, wherein the latent image bearing member has a dielectric layer on a surface thereof, and the dielectric layer has a thickness of 25 μm or less.

9. An image forming apparatus comprising a process cartridge and a fixing unit,
wherein the process cartridge comprises:
a latent image bearing member; and
a developing apparatus which carries a one-component developer to a developing region facing the latent image bearing member and adheres the one-component developer to a latent image on the latent image bearing member for development,
wherein the process cartridge integrally supports the latent image bearing member and the developing apparatus,
wherein the fixing unit fixes a transfer image transferred on a recording medium,
wherein the developing apparatus includes:
a developer bearing member which carries the one-component developer;
a charge imparting member which is disposed in contact with the developer bearing member and charges the one-component developer on the developer bearing member; and
a bias supplying member which supplies a bias voltage to the charge imparting member,
wherein the one-component developer has a volume resistivity of 8.0 logΩ·cm to 10.9 logΩ·cm, and
wherein the developing apparatus satisfies the following formula:
(K−1)^{0.75}/v^{0.25}<0.7×R_{T}−6.6
where:
v [m/sec] is a surface moving speed of the latent image bearing member contacting the developer bearing member at a surface moving in an identical direction as the developer bearing member;
v′ [m/sec] is a surface moving speed of the developer bearing member;
K is a ratio v′/v of the surface moving speed of the developer bearing member and the surface moving speed of the latent image bearing member; and
R_{T} [logΩ·cm] is a volume resistivity of the one-component developer.
